(19) United States
(12) Patent Application Publication
(10) Pub. No.: US 2026/0111856 A1
(43) Pub. Date: Apr. 23, 2026

(54) INFORMATION PROCESSING APPARATUS, INFORMATION PROCESSING METHOD, AND PROGRAM

(71) Applicants: Sony Group Corporation, Tokyo (JP); Sony Semiconductor Solutions Corporation, Kanagawa (JP)

(72) Inventors: Kenta ABE, Kanagawa (JP); Toshihiro KOBAYASHI, Tokyo (JP)

(73) Assignees: Sony Group Corporation, Tokyo (JP); Sony Semiconductor Solutions Corporation, Kanagawa (JP)

(21) Appl. No.: 19/117,640

(22) PCT Filed: Nov. 21, 2023
(86) PCT No.: PCT/JP2023/041805

§ 371 Date: Apr. 2, 2025

(30) Foreign Application Priority Data
Mar. 23, 2023 (JP) 2023-046703

(51) Int. Cl. G06Q 10/40

(52) U.S. Cl. CPC G06Q 10/40

(57) ABSTRACT

An information processing apparatus including circuitry configured to acquire engagement data from a user terminal in relation to a presentation of a first content for a first period, confirm validity of the acquired engagement data, store the acquired engagement data for which validity is confirmed to a corresponding engagement data database, and initiate presentation of a second content by the user terminal for a second period.

### CROSS REFERENCE TO RELATED APPLICATIONS

This application claims the benefit of Japanese Priority Patent Application JP 2023-046703 filed Mar. 23, 2023, the entire contents of which are incorporated herein by reference.

### TECHNICAL FIELD

The present disclosure relates to an information processing apparatus, an information processing method, and a program.

### BACKGROUND ART

In recent years, there has been known a technology that provides a virtual space in which various types of content such as a 3D model and a 2D image (referred to also as virtual objects) are disposed by a virtual space server. A user can experience the virtual space by a user terminal in various forms such as a smartphone, a head-mounted display (HMD), and a PC. An avatar that is associated with the user and can be operated by the user may be disposed in the virtual space.

For example, Patent Literature 1 discloses a technology that detects and analyzes a reaction of an avatar with a virtual object disposed in a virtual space in his/her field of view.

### CITATION LIST

### Patent Literature PTL 1: Japanese Unexamined Patent Application Publication No. 2010-535362

### SUMMARY

### Technical Problem

In order to provide content according to a user's reaction, it is desired to acquire data indicating behavior of the user on content disposed in a virtual space.

In this regard, the present disclosure provides an information processing apparatus, an information processing method, and a program that are capable of acquiring data in order to provide content according to a user's reaction by controlling presentation of content in accordance with acquisition of data indicating behavior of the user on the content.

### Solution to Problem

According to the present disclosure, an information processing apparatus is provided that includes circuitry configured to acquire engagement data from a user terminal in relation to a presentation of a first content for a first period, confirm validity of the acquired engagement data, store the acquired engagement data for which validity is confirmed to a corresponding engagement data database, and initiate presentation of a second content by the user terminal for a second period.

Furthermore, according to the present disclosure, an information processing method includes acquiring engagement data from a user terminal in relation to a presentation of a first content for a first period, confirming validity of the acquired engagement data, storing the acquired engagement data for which validity is confirmed to a corresponding engagement data database, and initiating presentation of a second content by the user terminal for a second period.

In addition, according to the present disclosure, a non-transitory computer-readable medium is provided having embodied thereon a program, which when executed by a computer causes the computer to execute an information processing method, the method including acquiring engagement data from a user terminal in relation to a presentation of a first content for a first period, confirming validity of the acquired engagement data, storing the acquired engagement data for which validity is confirmed to a corresponding engagement data database, and initiating presentation of a second content by the user terminal for a second period.

### BRIEF DESCRIPTION OF DRAWINGS

FIG. 1 is a diagram showing a configuration of an entire information processing system 1 according to an embodiment of the present disclosure.

FIG. 2 is a block diagram showing an example of a configuration of a content server 30 according to this embodiment.

FIG. 3 is a diagram showing an example of an analysis result 510 according to this embodiment.

FIG. 4 is a sequence diagram showing a first example of operation processing during initial connection according to this embodiment.

FIG. 5 is a sequence diagram showing a second example of the operation processing during initial connection according to this embodiment.

FIG. 6 is a sequence diagram showing operation processing during experience of a metaverse according to this embodiment.

FIG. 7 is a sequence diagram showing a first example of operation processing during analysis according to this embodiment.

FIG. 8 is a sequence diagram showing a second example of the operation processing during analysis according to this embodiment.

FIG. 9 is a diagram showing a configuration of an entire information processing system 2 according to a modified example of this embodiment.

FIG. . 10 is a block diagram showing an example of a hardware configuration of an information processing apparatus 900.

### DESCRIPTION OF EMBODIMENTS

A suitable embodiment of the present disclosure will be described below with reference to the accompanying drawings. Note that in the present specification and drawings, components having substantially the same functional configurations will be denoted by the same reference symbols and overlapping description will be omitted.

Further, description will be made in the following order.
1. Configuration
1-1. System configuration
1-2. Configuration of content server 30
2. Operation processing
2-1. First example of operation processing during initial connection
2-2. Second example of operation processing during initial connection
2-3. Operation processing during experience of metaverse
2-4. First example of operation processing during analysis
2-5. Second example of operation processing during analysis
3. Modified example
3-1. First modified example
3-2. Second modified example
3-3. Third modified example
3-4. Fourth modified example
4. Hardware configuration
5. Supplement

### 1. Configuration

An information processing system according to an embodiment of the present disclosure will be specifically described with reference to the drawings.

### <<1. System Configuration>>

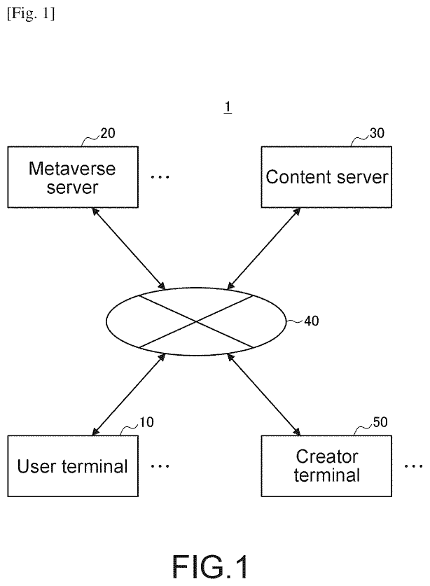

FIG. 1 is a diagram showing a configuration of an entire information processing system 1 according to an embodiment of the present disclosure. The information processing system 1 according to this embodiment includes one or more metaverse servers 20, a content server 30 (an example of an information processing apparatus), one or more user terminals 10 (an example of an information processing terminal) used by respective users, and one or more creator terminals 50 used by respective creators to generate respective pieces of content.

The metaverse server 20 establishes a metaverse (virtual space) and appropriately provides metaverse information (virtual space information) necessary for drawing the metaverse to the user terminal 10 via a network 40. The metaverse server 20 may be prepared for each of different metaverses. Each of the plurality of metaverse servers 20 may be a separate physical server or a separate virtual server running on one physical server. Further, the different metaverses may be provided by different business entities.

The metaverse information is, for example, map data of a metaverse and position information or state information (e.g., facial expression, posture, orientation, color, or state of shape) of content (virtual object) to be disposed in the metaverse. In this embodiment, metaverse video from the user's point of view is drawn on the basis of the metaverse information in the user terminal 10. In the present specification, examples of the content include a 3D model, a moving image, a 2D image, and audio data. Specific examples of the content include 3D models of an avatar of each user (joiner) (hereinafter, referred to also as a user avatar), an item worn by the avatar, an object such as a building to be disposed in a virtual space, and an avatar of an artist (organizer). Other examples of the content include a live music event with the avatar of the artist, music, and a space itself in which a 3D object, a 2D object, or the like attached to the music is disposed.

The position, posture, action, facial expression, and the like of the user avatar can be operated by the user using the user terminal 10. The metaverse server 20 transmits operation information of a user who joins (enters) a metaverse, which is received from the user terminal 10 associated with the user, to the user terminal 10 associated with another user who joins (enters) the same metaverse. This allows the position, posture, action, facial expression, and the like of each user avatar to be synchronized in the user terminal 10 of each user who joins (enters) the same metaverse. Further, the user's point of view may be the point of view of the user avatar associated with the user or the point of view with the user avatar as the center of the angle of view.

The content server 30 is an information processing apparatus that stores and manages data of content that can be disposed in a metaverse. Each piece of content is generated by, for example, a creator and stored in the content server 30. Examples of the data of content include body data of the content (such as a 3D model, a moving image, a 2D image, and audio data) and various types of additional information attached to the content (e.g., information for expressing the position and posture where a 3D model is disposed and the object size, such as Bounding Box, a parameter relating to appearance such as an object color and material, the state of the content, or the sequence length, speed, and the like of a moving image and animation, which will be referred to also as metadata below.). The data of content may be transmitted from the content server 30 to the user terminal 10 or may be transmitted to the user terminal 10 via the metaverse server 20.

The content server 30 transmits the metadata of content to the metaverse server 20. Further, the content server 30 may transmit the data of content (including at least body data of the content) to the user terminal 10. In the user terminal 10, when drawing metaverse video from the user's point of view on the basis of the metaverse information received from the metaverse server 20, the content (e.g., a user avatar) can be drawn at the position indicated by the metaverse information on the basis of the body data of the corresponding content received from the content server 30.

Note that the content may be file data in which video data, audio data, and various types of metadata are stored. In this case, in the user terminal 10, the content data received from the content server 30 may be played back (audio output, video output, or motion playback) in accordance with a playback instruction included in the metaverse information.

Further, all pieces of content disposed in a virtual space do not necessarily need to be stored in the content server 30. The data of some pieces of content that are not managed by the content server 30 according to this embodiment may be stored in the metaverse server 20 and transmitted from the metaverse server 20 to the user terminal 10.

The user terminal 10 is an information processing terminal used by a user. The user terminal 10 is realized by, for example, a smartphone, a tablet terminal, a personal computer (PC), a head mounted display (HMD) that covers the entire field of view, a glasses-type display device, or a projector.

The user terminal 10 draws (displays) or outputs, as audio in the metaverse, metaverse video in which respective pieces of content are disposed from the user's point of view by using the metaverse information received from the metaverse server 20 and the data of content received from the metaverse server 20 or the content server 30. Further, the user terminal 10 performs control of transmitting operation information of the user on the user avatar to the metaverse server 20. Note that such various types of control of the user terminal 10 may be executed a client module (application) installed in the user terminal 10 in advance. The client module may be provided from the operator who operates the metaverse.

The creator terminal 50 is a terminal used by a creator who has generated content.

The creator terminal 50 is realized by, for example, a smartphone, a tablet terminal, a personal computer (PC), or a head mounted display (HMD) that covers the entire field of view.

### (Organization of Problems)

In order for the content creator (e.g., creator) to edit content or create new content, it is desirable that the content creator appropriately acquires data indicating the behavior (reaction) of the user on the content.

In this regard, in this embodiment, presentation (display or playback) of content is controlled in accordance with acquisition of data indicating the behavior of a user on the content to make it possible to appropriately acquire data for presenting content according to the user's reaction. As a result, the content creator (e.g., creator) can edit the content on the basis of the user's reaction (behavior), provide content reflecting the user's reaction, and reflect the user's rection when creating new content.

The outline of the information processing system 1 according to an embodiment of the present disclosure has been described above. Note that the system configuration shown in FIG. 1 is an example, and the present disclosure is not limited thereto.

Next, a specific configuration of the content server 30 included in the information processing system 1 according to this embodiment will be described with reference to the drawings.

### <<2. Configuration of Content Server 30>>

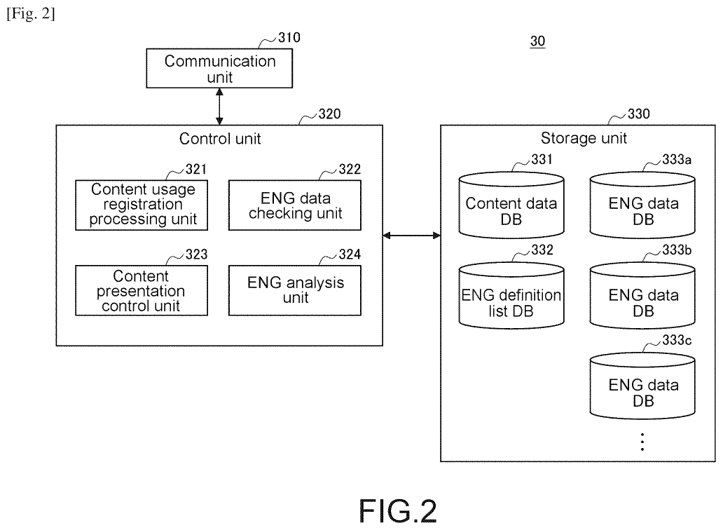

FIG. 2 is a block diagram showing an example of the configuration of the content server 30 according to this embodiment. As shown in FIG. 2, the content server 30 includes a communication unit 310, a control unit 320, and a storage unit 330.

### (Communication Unit 310)

The communication unit 310 includes a transmission unit that transmits data to an external device and a reception unit that receives data from the external device. The communication unit 310 according to this embodiment may be connected to the external device or the Internet for communication by using, for example, a wired or wireless local area network (LAN), Wi-Fi (registered trademark), Bluetooth (registered trademark), or a mobile communication network (long term evolution (LTE), a 4th generation mobile communication system (4G), and a 5th generation mobile communication system (5G)).

For example, the communication unit 310 transmits the metadata of content to the metaverse server 20 via the network 40. Further, the communication unit 310 transmits the data of content (including at least body data) to the user terminal 10 via the network 40.

Further, the communication unit 310 functions also as an acquisition unit that acquires (receives) engagement data (an example of data indicating the behavior of a user) from the user terminal 10 via the network 40. Further, the communication unit 310 transmits an analysis result of the engagement data to the creator terminal 50 via the network 40.

### (Control Unit 320)

The control unit 320 functions as an arithmetic processing unit and a control device and controls the general operation in the content server 30 in accordance with various programs. The control unit 320 is realized by, for example, a central processing unit (CPU) or an electronic circuit such as a microprocessor. Further, the control unit 320 may include a read only memory (ROM) for storing programs to be used, operation parameters, and the like, and a random access memory (RAM) for temporarily storing parameters that appropriately change, and the like.

Further, the control unit 320 functions also as a content usage registration processing unit 321, an ENG data checking unit 322, a content presentation control unit 323, and an ENG analysis unit 324.

The content usage registration processing unit 321 performs usage registration processing of content in accordance with a request from the metaverse server 20. Specifically, the content usage registration processing unit 321 checks whether or not the metaverse server 20 has a right to use content stored in a content data DB (database) 331 of the storage unit 330 (hereinafter, referred to as a right of use) and performs, in the case where it has been confirmed that the metaverse server 20 has the right of use of content, processing of transmitting a usage ID of the content and metadata of the content to the metaverse server 20. For example, assumption is made that the metaverse server 20 has the right of use of content in the case where the operator of the metaverse server 20 has requested a creator to generate content, the operator has purchased content from a creator, a creator belongs to the operating company of the metaverse server 20, the operator of the metaverse server 20 is a creator himself/herself, or a creator has requested the operator of the metaverse server 20 to use content. Note that the method of checking the right of use is not particularly limited. Further, the right of use is a right to use content and is not particularly limited although more specifically, assumption is made that a content (copyrighted work) license agreement has been made with a creator.

The ENG data checking unit 322 checks the validity of engagement data (hereinafter, referred to as the ENG data) acquired by the communication unit 310 (acquisition unit), which is an example of data indicating the behavior of a user on content. Examples of the ENG data include the behavior (e.g., the user avatar approaches, moves away from, or waves to content) of the user on content (via the user avatar) such as information regarding the line of sight of the user avatar on content, a portion where the line of sight of the user avatar crosses content data (i.e., a region where the user avatar is gazing at the content), and a portion of the content or user avatar (distinction of the right hand and left hand of the user avatar) when the user avatar came into contact with the content, time information (timestamp) indicating the timing at which they occurred or elapsed time, an action speed and acceleration, and information regarding voice conversation that has occurred between the content and the user. What kind of behavior is used as the ENG data is defined for each piece of content by an ENG definition list (an example of a behavior definition list). The ENG definition list may be generated by a creator. Further, the ENG definition list for each piece of content may differ depending on the metaverse to be used or the function or performance of the user terminal.

The method of checking validity is not particularly limited. For example, the ENG data checking unit 322 makes sure that the ENG data is not empty, fake, corrupted, or otherwise invalid. Further, the ENG data checking unit 322 may make sure that the ENG data acquired by the communication unit 310 is the ENG data defined by the ENG definition list.

Further, the ENG data checking unit 322 stores the ENG data whose validity has been confirmed in an ENG data DB 333 of the storage unit 330 in association with content (e.g., together with the usage ID of content transmitted from the user terminal 10 together with the ENG data). Note that the content in this embodiment may be provided to a plurality of metaverses. For example, one piece of content is used in both a first metaverse and a second metaverse different from the first metaverse. The ENG data checking unit 322 recognizes in which metaverse the content that is the target of the ENG data was used and stores the ENG data for each metaverse. Specifically, the ENG data checking unit 322 stores the corresponding ENG data in the ENG data DB 333 (ENG data DBs 333a, 333b, 333c, . . . ) corresponding to the respective metaverses.

In which metaverse the target content is used may be determined from, for example, the usage ID of content received from the user terminal 10 together with the ENG data. Alternatively, assumption is made that in the case where the client module (application) that draws metaverse video, acquires the ENG data, and transmits the ENG data is operated in the user terminal 10, this client module is associated with the metaverse. For example, assumption is made that the operator who operates the metaverse provides a dedicated client module. In this case, the ENG data checking unit 322 is capable of receiving an ID of the client module (module ID) from the user terminal 10 and determining the corresponding metaverse from the module ID.

The content presentation control unit 323 controls presentation of content in the user terminal 10. Specifically, the content presentation control unit 323 may perform control of permitting or blocking presentation (display or playback) of content in the user terminal 10. For example, the content presentation control unit 323 may perform processing of permitting presentation of content, not permitting presentation of content, mosaicking content, or the like. Examples of the presentation of content in the user terminal 10 include, more specifically, drawing an avatar using an avatar 3D model, playing back a moving image, displaying a 2D image, and outputting (playing back) audio data.

The control of permitting presentation of content is control of permitting presentation of content in a predetermined period. For example, the content presentation control unit 323 may transmit, as the control of permitting presentation of content, information indicating a predetermined period in which the presentation of content is permitted (referred to also as expiration information) to the user terminal 10. More specifically, the content presentation control unit 323 transmits, in the case where the ENG data checking unit 322 has confirmed the validity of the ENG data (data indicating the behavior of a user on content (an example of first content)), information indicating a second predetermined period after the first predetermined period in which the ENG data was acquired (an example of expiration information) to the user terminal 10 as the control of permitting presentation of the content (an example of second content) in the second predetermined period. In the user terminal 10, when drawing metaverse video, the content can be drawn during the period permitted by the content server 30. Further, in the user terminal 10, during the period in which the content is drawn, the ENG data corresponding to the content is acquired and transmitted to the content server 30 and permission of presentation of the content in the next period is obtained. The content presentation control unit 323 is capable of more reliably acquiring the ENG data of content by performing control of permitting presentation of content in the second pre-determined period after the first predetermined period in the user terminal 10 in exchange for acquisition of the ENG data from the user terminal 10 in the first predetermined period in which the content can be presented.

The predetermined period may be, for example, a few tens of seconds or one minute. As an example, the expiration information is information indicating the length of time such as a few tens of seconds and one minute. As a result, the content presentation control unit 323 is capable of performing processing of acquiring the ENG data, checking the validity of the ENG data, and controlling permission or non-permission of presentation of content every few tens of seconds or every minute. The content presentation control unit 323 is capable of acquiring the ENG data of content in real time. Note that the length of the predetermined period is not limited to the example described above, and may be determined on the basis of the traffic or the overhead of the ENG data. Note that the expiration information is not limited to information simply indicating the length of time and may be, for example, information indicating the date and time after a predetermined period (not particularly limited) such as a few tens of seconds, one minute, five minutes, and ten minutes has elapsed since the validity was confirmed.

Note that the content to be transmitted to the user terminal 10 may be encrypted in advance. In this case, the content presentation control unit 323 transmits, as the control of permitting presentation of content, the expiration information including information necessary for decryption (authentication information) to the user terminal 10. In the user terminal 10, the content can be decrypted on the basis of the information necessary for decryption included in the expiration information and presented only during a predetermined period. The confirmation of the validity of the ENG data by the ENG data checking unit 322 can be said to be authentication.

Further, in the case where information indicating the predetermined period is transmitted to the user terminal 10 in advance or information indicating the predetermined period is set in the user terminal 10, the content presentation control unit 323 may transmit, as the control of permitting presentation of content, content presentation permission information indicating that presentation of content is permitted to the user terminal 10. The user terminal 10 performs, upon receiving the content presentation permission information, control of presenting content in the next predetermined period.

The control of blocking presentation of content is control of blocking presentation of content in a predetermined period. For example, the content presentation control unit 323 may block, in the case where it has been confirmed that the ENG data is not valid, the presentation of content by not transmitting the next expiration information (information indicating a second predetermined period) or content presentation permission information to the user terminal 10. In the user terminal 10, since the content can be drawn only during the period permitted by the content server 30, the content cannot be drawn (e.g., cannot be decrypted) in the case where the expiration information or content presentation permission information cannot be received from the content server 30. In this case, the user terminal 10 may hide the content, reduce the display quality of the content, mosaics the content, or replace the content with another predetermined indication (e.g., characters such as “Not authenticable”). The presentation control in the user terminal 10 in the case where the expiration information or content presentation permission information cannot be received (not authenticated) may be defined in the ENG definition list received from the content server 30 in advance.

Further, the content presentation control unit 323 may block, as another example of the blocking control, the presentation of content in the user terminal 10 by transmitting information indicating that the presentation of content is not permitted (referred to as content presentation non-permission information or a block signal) to the user terminal 10 in the case where it has been confirmed that the ENG data is not valid. In the user terminal 10, the content becomes undrawable (e.g., becomes undecryptable) in accordance with the block signal received from the content server 30.

Further, the content presentation control unit 323 may perform, as the content presentation control, control of transmitting a checking result of the validity, which indicates whether or not the validity of the ENG data could be confirmed, to the user terminal 10. Assumption is made that in the user terminal 10, information indicating the predetermined period is received or set in advance. The user terminal 10 performs control of presenting content in the next predetermined period in the case where the validity has been confirmed and does not present (or restrains display of) content in the case where the validity has not been confirmed. Note that the content presentation control unit 323 may perform control of transmitting the checking result of the validity, which indicates that the validity could be confirmed, and the next expiration information to the user terminal 10.

The ENG analysis unit 324 analyzes the ENG data of each piece of content stored in the ENG data DB 333. Since the content can be provided to a plurality of metaverses as described above, the ENG analysis unit 324 may analyze the ENG data of each piece of content for each metaverse. The ENG analysis unit 324 may calculate the number of times of each ENG defined in the ENG definition list, and the like. For example, the ENG analysis unit 324 may calculate the number of views of content, the viewing time, the number of contacts by a user (user avatar), the number of times the line of sight of a user (user avatar) is directed, the number of people the line of sight is directed, and the like. The number of times the line of sight is directed may be, for example, the number of times of gazing for a certain period of time or more.

The analysis result is transmitted to, for example, the creator terminal 50. The creator can view the analysis result of the ENG data of the content generated by himself/herself, edit the content, and think about the next work by using the creator terminal 50. Further, by immediately performing a series of actions from viewing of an analysis result to content editing, it is possible to reflect, in real time, the editing result on the content created by himself/herself in the metaverse. Further, the creator can grasp how much the content generated by himself/herself contributed to the metaverse from the analysis result and claim legitimate revenue.

Further, the analysis result may be viewed by the operator of the metaverse and used when the operator returns revenue to the creator, for example. Further, the analysis result is used for various other purposes. Note that the ENG analysis unit 324 is capable of analyzing the ENG data in real time and outputting the analysis result.

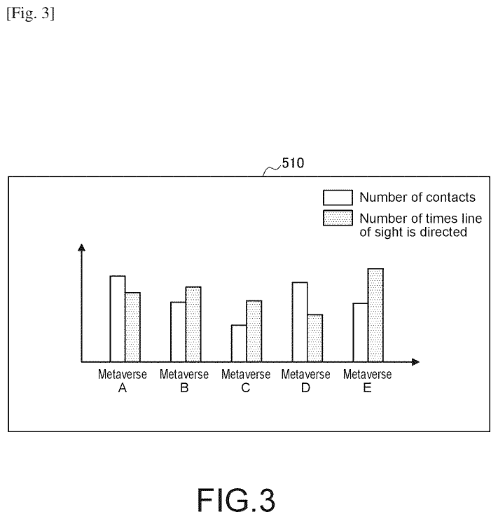

FIG. 3 is a diagram showing an example of an analysis result 510 according to this embodiment. The analysis result 510 shown in FIG. 3 is an analysis result of the ENG data in each metaverse in the case where content is provided to metaverses A to E. As shown in FIG. 3, as the analysis result 510, for example, the number of contacts and the number of times the line of sight is directed are displayed graphically for each metaverse. As a result, the creator and the like can intuitively grasp the difference in the degree of attention of the target content for each metaverse. Note that the analysis result according to this embodiment is not limited to the analysis result 510 shown in FIG. 3. The analysis according to this embodiment is performed from various perspectives and the various methods of expressing the analysis result are conceivable.

### (Storage Unit 330)

The storage unit 330 is realized by a ROM for storing programs to be used for processing of the control unit 320, operation parameters, and the like, and a RAM for temporarily storing parameters that appropriately change.

The storage unit 330 includes the content data DB 331 for storing body data and metadata of content, an ENG definition list DB 332 for storing an ENG definition list of content, and the ENG data DBs 333a to 333c, . . . for storing ENG data of content for each metaverse.

Although the configuration of the content server 30 has been specifically described above, the configuration of the content server 30 according to an embodiment of the present disclosure is not limited to the example shown in FIG. 2. For example, the content server 30 does not necessarily need to have all the configurations shown in FIG. 2. Further, the content server 30 may be realized by a plurality of devices.

### Operation Processing

Next, operation processing according to this embodiment will be described.

<2-1. First Example of Operation Processing during Initial Connection>

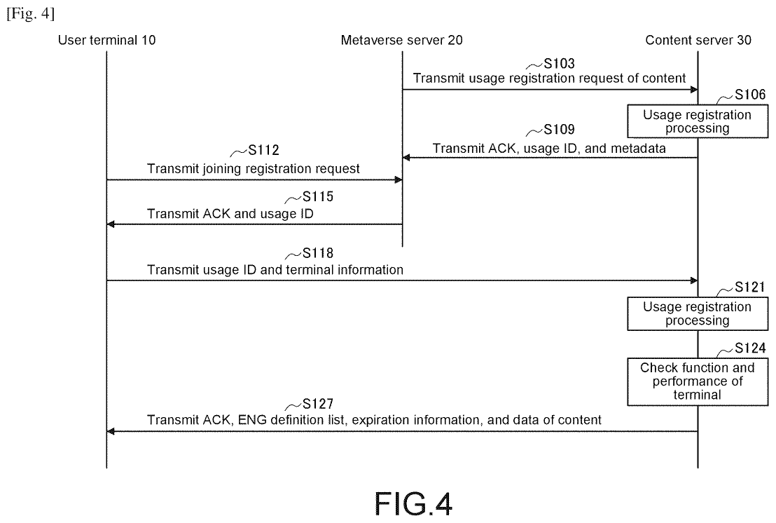

FIG. 4 is a sequence diagram showing a first example of the operation processing during initial connection according to this embodiment. In the first example, a case where the metaverse server 20 (i.e., the operator of the metaverse) has the right of use of content will be described. Assumption is made that the content is, for example, live video recorded by an artist.

As shown in FIG. 4, first, the metaverse server 20 transmits, regarding content to be used in a metaverse, a usage registration request of the content to the content server 30 (Step S103). In this embodiment, assumption is made that a usage registration request of the content that the metaverse server 20 has the right of use in advance is transmitted.

Next, the content usage registration processing unit 321 of the content server 30 performs usage registration processing of the content (Step S106). Specifically, the content usage registration processing unit 321 checks whether or not the metaverse server 20 has the right of use of the target content.

Next, the content usage registration processing unit 321 transmits, when it has been confirmed that the metaverse server 20 has the right of use of the target content, ACK (Acknowledgment), the usage ID of content, and the metadata of content to the metaverse server 20 (Step S109). The usage ID of content includes information indicating the position of the content (the position of the content server 30 for accessing the content). Further, the usage ID of content may further include information indicating the metaverse using the content (metaverse ID).

Meanwhile, the user terminal 10 transmits, to the metaverse server 20 that provides a metaverse to be joined, a joining registration request for the metaverse (Step S112).

Next, the metaverse server 20 transmits ACK and the usage ID of content to be used in the metaverse to the user terminal 10 (Step S115). Assumption is made that the content to be used in the metaverse is a 3D model, a moving image, a 2D image, audio data, or the like as described above. Examples of the content to be used in the metaverse include, more specifically, an avatar, a performance sound source (live audio data), live video, sports match video, a movie, a character 3D model, an item, an accessory, and a metaverse space itself. Note that all pieces of content to be used in the metaverse do not necessarily need to be managed by the content server 30. Assumption is also made that the metaverse server 20 transmits body data of some pieces of content to be used in the metaverse (e.g., various virtual objects such as buildings disposed in the metaverse and environments, image data, or 3D models of avatars) to the user terminal 10.

Subsequently, the user terminal 10 transmits the usage ID of content received from the metaverse server 20 and the terminal information of the user terminal 10 to the content server 30 (Step S118).

Next, the content server 30 performs usage registration processing of content in the user terminal 10 by the content usage registration processing unit 321 (Step S121). Specifically, the content usage registration processing unit 321 checks (authenticates) whether or not the usage ID is valid. For example, the content usage registration processing unit 321 checks whether or not the usage ID received from the user terminal 10 matches the usage ID issued in the Step S106 described above. Further, the content usage registration processing unit 321 may store information indicating the user terminal 10 (e.g., a terminal ID) as the user of the target content and the corresponding metaverse (e.g., a metaverse ID) in association with information indicating the target content information (e.g., a content ID) in the storage unit 330 as usage registration information.

Subsequently, the content usage registration processing unit 321 of the content server 30 checks the function and performance of the user terminal 10 on the basis of the terminal information of the user terminal 10 (Step S124). Such checking is checking of whether or not the user terminal 10 is a terminal capable of acquiring the ENG data defined in the ENG definition list associated with the target content. The content usage registration processing unit 321 may appropriately change the ENG definition list depending on the function and performance of the user terminal 10. The allowable range of changes may be set in advance by the creator who has generated the target content.

The content server 30 then transmits ACK, the ENG definition list, the expiration information, and the data of content (including at least body data of content) to the user terminal 10 (Step S127). The expiration information is information for permitting presentation of the target content in the first predetermined period. Note that the user terminal 10 may have the information indicating the predetermined period in advance. In this case, the content server 30 transmits ACK, the ENG definition list, content presentation permission information (information indicating that presentation of content is permitted), and the data of content to the user terminal 10. The user terminal 10 presents (displays or plays back) the content during the predetermined period in accordance with the content presentation permission information received from the content server 30. Further, the data of content (body data) does not necessarily need to be transmitted from the content server 30 and may be transmitted from the metaverse server 20.

<2-2. Second Example of Operation Processing during Initial Connection>

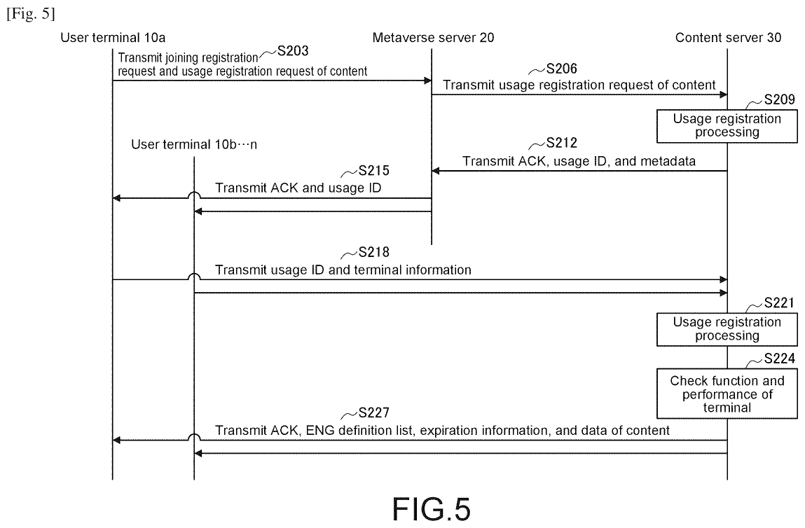

FIG. 5 is a sequence diagram showing a second example of the operation processing during initial connection according to this embodiment. In the second example, a case where the user terminal 10 (i.e., a user) has the right of use of content will be described. Assumption is made that the content is, for example, an avatar purchased by the user.

As shown in FIG. 5, first, the user terminal 10a transmits, to the metaverse server 20 that provides a metaverse to be joined, a joining registration request for the metaverse and a usage registration request of content (Step S203). In this embodiment, assumption is made that a usage registration request of the content (e.g., a user avatar) that the user terminal 10a has the right of use in advance is transmitted.

Next, the metaverse server 20 transmits the usage registration request of content received from the user terminal 10a to the content server 30 (Step S206). In this embodiment, the metaverse server 20 acts on behalf of a usage registration request of content from the user terminal 10a.

Subsequently, the content usage registration processing unit 321 of the content server 30 performs usage registration processing of content (Step S209). Specifically, the content usage registration processing unit 321 checks whether or not the user terminal 10 has the right of use of the target content.

Next, the content usage registration processing unit 321 transmits, in the case where it has been confirmed that the user terminal 10 has the right of use of the target content, ACK, the usage ID of content, and the metadata of content to the metaverse server 20 (Step S212).

Subsequently, the metaverse server 20 transmits ACK and each usage ID of content to be used in the metaverse to each user terminal 10 (the user terminals 10a, 10b, . . . ) that joins the metaverse (has transmitted a joining registration request) (Step S215).

Subsequently, each user terminal 10 (the user terminals 10a, 10b, . . . ) transmits the usage ID of content received from the metaverse server 20 and the terminal information of the user terminal 10 to the content server 30 (Step S218).

Next, the content server 30 performs usage registration processing of content in each user terminal 10 by the content usage registration processing unit 321 (Step S221).

Subsequently, the content usage registration processing unit 321 of the content server 30 checks the function and performance of the user terminal 10 on the basis of the terminal information of each user terminal 10 (Step S224).

The content server 30 then transmits ACK, the ENG definition list, the expiration information, and the data of content (including at least body data of content) to each user terminal 10 (Step S227). The expiration information is information indicating the first predetermined period in which the presentation of the target content is permitted, similarly to the case described with reference to FIG. 4. As a result, it is possible to present the content that the user terminal 10a has the right of use and uses in the metaverse (e.g., a user avatar) also in the other user terminals 10b, . . . , in addiction to the user terminal 10a having the right of use in advance. Note that the user terminal 10 (10a to 10n) may have information indicating the predetermined period in advance. In this case, the content server 30 transmits ACK, the ENG definition list, the content presentation permission information, and the data of content to the user terminal 10. The user terminal 10 presents (displays or plays back) the content during the predetermined period in accordance with the content presentation permission information received from the content server 30. Further, the data of content (body data) does not necessarily need to be transmitted from the content server 30 and may be transmitted from the metaverse server 20.

<2-3. Operation Processing during Experience of Metaverse>

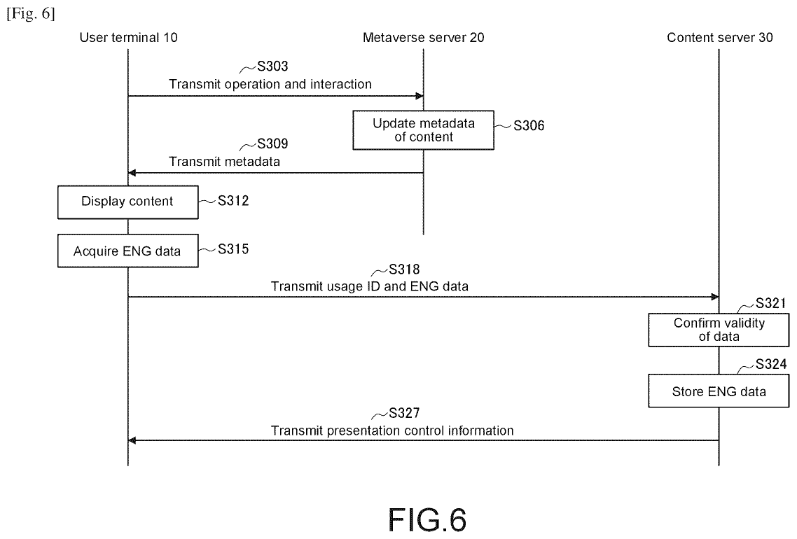

FIG. 6 is a sequence diagram showing operation processing during experience of a metaverse according to this embodiment. The operation processing shown in FIG. 6 is executed after the initial connection processing shown in FIG. 4 or FIG. 5.

As shown in FIG. 6, first, the user terminal 10 transmits a user's operation and a user's (or user avatar's) interaction to the metaverse server 20 (Step S303). The user's operation (operation information) means, for example, an operation of movement, gesture, action, or pause of the user avatar and is input from the operation input unit of the user terminal 10. Further, the user's (or user avatar's) interaction means movement, facial expression, voice, or the like of the user(or user avatar). The user's interaction can be detected by, for example, various sensors such as a camera, a motion sensor, and a microphone provided in the user terminal 10. Further, the user's interaction detected by the various sensors may be reflected on the facial expression, gesture, or the like of the user avatar and transmitted to the metaverse server 20 as the user avatar's interaction. Further, the facial expression, gesture, action, or the like of the user avatar based on the user's operation (operation information) may be transmitted to the metaverse server 20 as the user avatar's interaction. Note that the user's interaction does not necessarily need to be transmitted to the metaverse server 20. What input information (operation information or interaction information) is transmitted from the user terminal 10 to the metaverse server 20 differs depending on the function of the user terminal 10.

Next, the metaverse server 20 updates the metadata of content in accordance with the user's operation or user's (user avatar's) interaction (Step S306). Specifically, in the case where the position or state(e.g., facial expression, posture, an orientation, or state of shape) of content has changed by the user's operation or interaction, the metaverse server 20 updates the metadata of the content (the position or state in the metaverse in this case). For example, in the case where a user avatar (an example of content) has performed an operation of holding a certain item (an example of content) and moving the held item to another place, the positions of the user avatar and item change and each piece of metadata is updated. Further, in the case where the user's operation is a playback instruction of a moving image (an example of content) disposed in the metaverse, the state of the moving image changes from the stopped state to the playback state and metadata is updated.

Subsequently, the metaverse server 20 transmits the updated metadata to the user terminal 10 (Step S309).

Next, the user terminal 10 displays (or plays back) the content on the basis of the metadata received from the metaverse server 20 (Step S312). Specifically, the user terminal 10 updates the position or state of the content on the basis of the metadata.

The processing shown in the Steps S303 to S309 described above may be continuously performed between the metaverse server 20 and each user terminal 10 that joins the metaverse. Further, the processing of transmitting metadata shown in Step S309 may be performed on each user terminal 10 that joins the metaverse as necessary (in the case of a metadata to be synchronized). As a result, the metadata of each piece of content used in the metaverse is synchronized between the user terminals 10 that join the metaverse. For example, in the case where the user of the user terminal 10a has performed an operation of holding a certain item and moving the held item to another place by the user avatar of himself/herself disposed in the metaverse, the positions of the user avatar and the item in the metaverse change depending on the operation. The updated metadata of the user avatar and item is transmitted to each user terminal 10 that joins the metaverse. As a result, in the metaverse video drawn by each user terminal 10 that joins the metaverse, how the user avatar holds the item and moves the held item to another place can be seen.

Subsequently, the user terminal 10 acquires the ENG data that is data indicating the behavior of the user on predetermined content during a period in which the predetermined content is displayed (or played back) (Step S315). The predetermined content is content whose presentation is permitted by the content server 30 in FIG. 4 or FIG. 5 (content that can be presented on the basis of the expiration information). The predetermined content may be each user avatar disposed in the metaverse, the item described above, or various other virtual objects.

As described above with reference to FIG. 4 or FIG. 5, the period (length of time) in which the predetermined can be displayed (or played back) is a predetermined period (first predetermined period) indicated by the expiration information received from the content server 30. Note that the user terminal 10 may have the information indicating the predetermined period in advance. In this case, the user terminal 10 presents (displays or plays back) the content during the predetermined period in accordance with the content presentation permission information received from the content server 30. Examples of the predetermined period include, but not limited to, a few tens of seconds and one minute. The user terminal 10 displays (or plays back) the predetermined content during the first predetermined period and acquires the ENG data of the predetermined content. What type of ENG data is acquired is defined by the ENG definition list received from the content server 30.

For example, in the case where the predetermined content is an item, examples of the ENG data include the contact of the user avatar with the item and the line of sight of the user avatar toward the item (whether or not the line of sight of the user avatar is directed). Further, in the case where the predetermined content is a different user avatar, examples of the ENG data include the contact of the user avatar with the different user avatar and the line of sight of the user avatar toward the different user avatar (whether or not the line of sight of the user avatar is directed toward the different user avatar). Further, in the case where the predetermined content is live video, examples of the ENG data include the length of time during which the live video is played back, the date and time, and movement (e.g., movement that expresses an emotion) of the user avatar during playback of the live video. Note that the user avatar is operated by the user (operation information is transmitted to the metaverse server 20), and data indicating the behavior of the user on the predetermined content(the ENG data) is acquired from the result of the user's operation.

Further, the ENG data defined by the ENG definition list may be the above-mentioned user's (user avatar's) interaction.

Next, the user terminal 10 transmits the usage ID of the predetermined content and the acquired ENG data to the content server 30 (Step S318).

Subsequently, the ENG data checking unit 322 of the content server 30 confirms the validity of the ENG data (Step S321).

Next, the ENG data checking unit 322 stores, when the validity of the ENG data has been confirmed, the ENG data in the ENG data DB 333 (Step S324). The ENG data checking unit 322 stores the ENG data for each metaverse using predetermined content associated with the ENG data. In the case where a client module operated in the user terminal 10 is associated with the metaverse, the ENG data checking unit 322 is also capable of specifying the metaverse by acquiring the identification information (module ID) of the source client module.

The content presentation control unit 323 then transmits presentation control information to the user terminal 10 (Step S327). The presentation control information is information relating to presentation control of predetermined content in the second pre-determined period after the first predetermined period in the user terminal 10. For example, the content presentation control unit 323 transmits, in the case where the ENG data is valid, the content presentation permission information or the expiration information indicating the second predetermined period as the presentation control information. The user terminal 10 is capable of continuously presenting (displaying or playing back), in the case where the content presentation permission information or the expiration information has been received, the predetermined content (content acquired in the Step S127 or S227 described above).

During experience of the metaverse, the processing shown in the Steps S315 to S327 described above is repeated and the user terminal 10 is capable of presenting the predetermined content in exchange for transmitting the ENG data of the predetermined content to the content server 30. The user terminal 10 may perform the transmission of the ENG data shown in the Step S318 described above before the expiration (before reaching the end time of the first predetermined period) to receive authentication from the content server 30 again.

Note that in the case where the validity of the ENG data could not be confirmed (e.g., determined to be invalid) in the Step S321 described above, the content presentation control unit 323 performs control of blocking presentation of content in the user terminal 10. As the control of blocking presentation of content, for example, the content presentation control unit 323 may avoid transmitting the next expiration information or may transmit information (block signal) indicating that the presentation of content is not permitted to the user terminal 10. Further, the content presentation control unit 323 may instruct, as another example of the control of blocking presentation of content, display restrictions such as displaying only part of the content (3D model), changing some expressions, e.g., mosaicking, and displaying Bounding Box or a simple model to the user terminal 10. Whether to perform display restrictions in the case where the validity of the ENG data could not be confirmed and the content of the display restrictions may be set by the creator of the content in advance.

By controlling, in accordance with the acquisition of the ENG data of content, presentation of the content in this way, it is possible to acquire data more reliably.

<2-4. First Example of Operation Processing during Analysis>

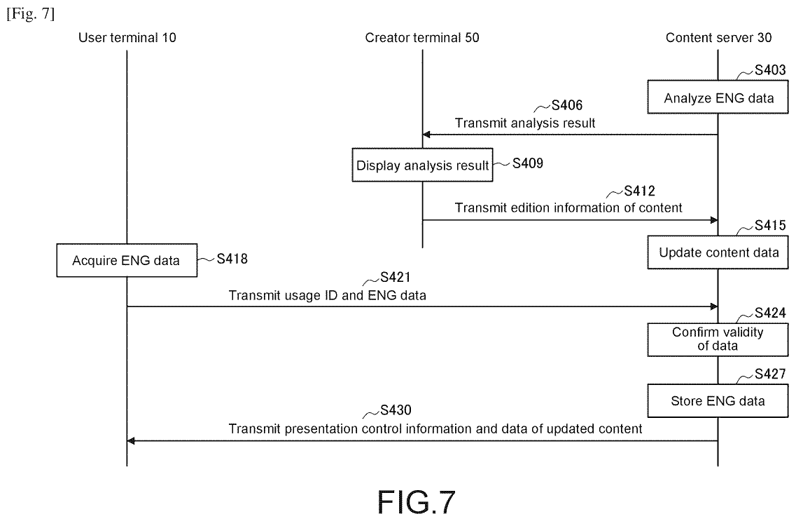

FIG. 7 is a sequence diagram showing a first example of operation processing during analysis according to this embodiment.

As shown in FIG. 7, first, the ENG analysis unit 324 of the content server 30 analyzes the ENG data (Step S403). The analysis may be periodically performed in real time while the content is presented in the user terminal 10 or may be performed after the presentation of the contents is finished in the user terminal 10.

Next, the content server 30 transmits the analysis result to the creator terminal 50 (Step S406).

Subsequently, the creator terminal 50 displays the analysis result (Step S409). The creator can intuitively recognize the degree of attention of content, and the like, from the analysis result (e.g., the analysis result 510 shown in FIG. 3) displayed on the creator terminal 50. Note that the creator can also edit the content in accordance with the analysis result. For example, it is conceivable that in the case where the degree of attention is low, the creator changes the shape of the content in order to increase the degree of attention. The creator can edit the content from an edition screen (not shown) displayed on the creator terminal 50.

Next, the creator terminal 50 transmits edition information of content to the content server 30 (Step S412).

Subsequently, the content server 30 updates, on the basis of the edition information, the data of the target content stored in the content data DB 331 (Step S415). Note that the data of edited content may be transmitted from the creator terminal 50 and overwritten and saved in the content data DB 331. The analysis may be performed in real time as described above, and the creator can also appropriately edit the content on the basis of the real-time analysis result.

In the case where the analysis and edition described above are performed in real time, the processing shown in Step S303 to Step S318 shown in FIG. 6 is continuously performed in the user terminal 10. In FIG. 7, Step S418 corresponding to Step S315 shown in FIG. 6 has been written first.

In the user terminal 10, the ENG data in a predetermined period (first predetermined period) in which content (first content) is presented is acquired (Step S418), and the usage ID of the content and the acquired ENG data are transmitted to the content server 30 (Step S421).

Subsequently, the ENG data checking unit 322 of the content server 30 confirms the validity of the ENG data (Step S424).

Next, the ENG data checking unit 322 stores, when the validity of the ENG data can be confirmed, the ENG data in the ENG data DB 333 (Step S427).

The content presentation control unit 323 then transmits the presentation control information (e.g., the expiration information or the content presentation permission information) and the data of the updated content to the user terminal 10 (Step S430). As a result, it is possible to present (display or play back) the content edited by the creator in real time, in the user terminal 10.

A case where content is updated by a creator in accordance with an analysis result has been described above.

<2-5. Second Example of Operation Processing during Analysis>

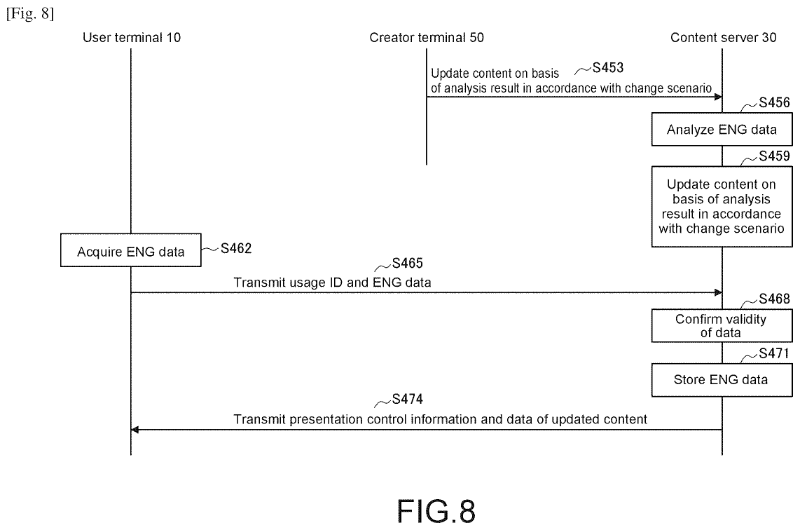

FIG. 8 is a sequence diagram showing a second example of operation processing during analysis according to this embodiment. Although a case where the creator edits the content has been described in the first example, this embodiment is not limited thereto and the content may be automatically changed by the content server 30. Specific description will be made below with reference to FIG. 8.

As shown in FIG. 8, first, the creator terminal 50 transmits a change scenario to be used when automatically changing content to the content server 30 (Step S453).

Subsequently, the ENG analysis unit 324 of the content server 30 analyzes the ENG data (Step S456).

Next, the control unit 320 of the content server 30 updates (changes) the content (content body data) on the basis of the analysis result in accordance with the change scenario (Step S459). The change scenario may be generated by a creator and received from the creator terminal 50 or may be prepared in advance by another method. In the change scenario, for example, how the content body data is changed in what kind of analysis result the analysis result of the ENG data is has been determined.

The processing of subsequent Steps S462 to S474 is similar to the processing shown in the processing shown in Steps S418 to S430 shown in FIG. 7.

As described above, in this embodiment, the content can be automatically changed on the basis of the analysis result of the ENG data regardless of the creator. Note that also in the case of automatically changing the content, the analysis result may be transmitted to the creator terminal 50.

Note that in this embodiment, the content to be permitted in the second predetermined period may be the same content (an example of second content) as the first content permitted in the first predetermined period acquired from the ENG data (see FIG. 6), or may be the content (an example of second content) obtained by updating (changing) the first content on the basis of the ENG data or the analysis result of the ENG data (see FIG. 7 and FIG. 8).

### 3. Modified Example

Next a modified example of this embodiment will be described.

### <<3-1. First Modified Example>>

The configuration of the information processing system 1 according to this embodiment is not limited to the example shown in FIG. 1. Various configurations of the information processing system 1 according to this embodiment are conceivable. Some examples will be described below.

For example, a plurality of content servers 30 may be provided. In this case, for example, content of a creator from a different affiliation may be stored for each content server 30. Alternatively, in the case where there is a lot of content, a plurality of content servers 30 may be prepared in order to distribute the processing load.

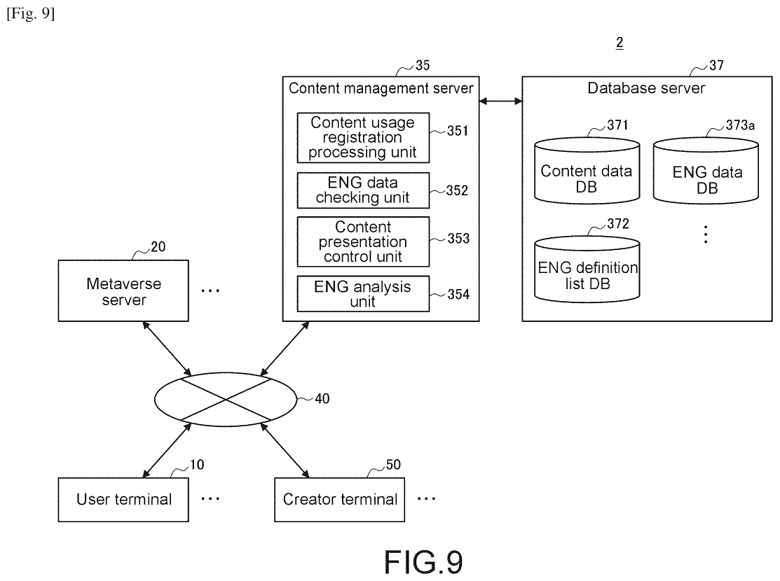

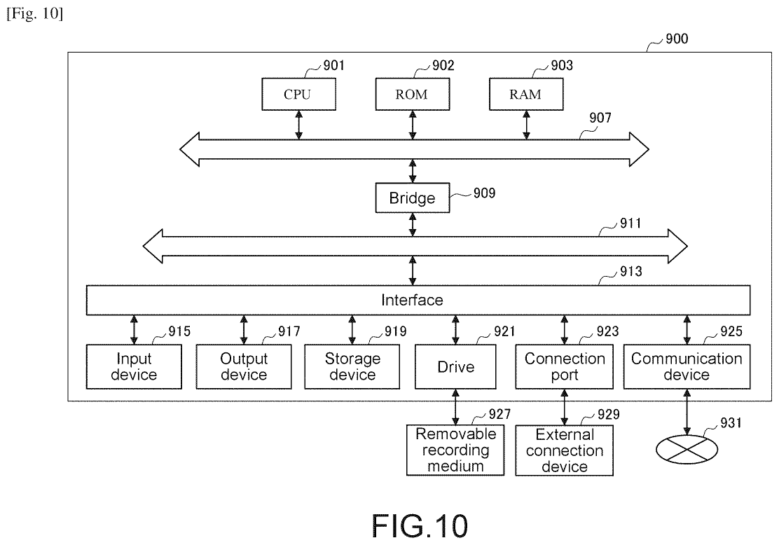

Further, the function of the control unit 320 of the content server 30 may be provided in another server. FIG. 9 is a diagram showing a configuration of an entire information processing system 2 according to a modified example of this embodiment. As shown in FIG. 9, the information processing system 2 includes one or more metaverse servers 20, a content management server 35 (an example of an information processing apparatus), a database server 37, one or more user terminals 10 (an example of an information processing terminal) to be used by respective users, and one or more creator terminals 50 to be used by respective creators who has generated respective pieces of content.

The content management server 35 has a functional configuration of a content usage registration processing unit 351, an ENG data checking unit 352, a content presentation control unit 353, and an ENG analysis unit 354 corresponding to the respective functions of the control unit 320 of the content server 30 shown in FIG. 1. Note that although not shown in FIG. 9, the content management server 35 includes a communication unit (acquisition unit) that acquires (receives) the ENG data from the user terminal 10 and a storage unit. Further, the respective functions of the content management server 35 are realized by the control unit of the content management server 35.

The database server 37 includes a content data DB 371, an ENG definition list DB 372, and an ENG data DB 373 (373a, . . . ) corresponding to the respective DBs stored in the storage unit 330 of the content server 30 shown in FIG. 1.

As described above, the information processing system according to this embodiment may have the configuration of the information processing system 2 shown in FIG. 9 in which the control unit 320 and the storage unit 330 of the content server 30 shown in FIG. 1 are configured in separate servers. Note that a plurality of content management servers 35 and a plurality of database servers 37 may be provided. Further, one content management server 35 may manage the plurality of database servers 37.

### <<3-2. Second Modified Example>>

It has been described that in the operation processing during analysis described with reference to FIG. 7 or FIG. 8, content is updated on the basis of an analysis result. The updating of content may be performed for each metaverse.

As described above, assumption is made that one piece of content is provided to a plurality of metaverses, and the ENG analysis unit 324 may perform analysis for each metaverse as shown in FIG. 3. At this time, it is conceivable that a creator wants to individually edit content so as to further increase the degree of attention for a specific metaverse.

In this regard, the control unit 320 of the content server 30 stores, in the content data DB 331, the data of content individually edited for a specific metaverse in association with a metaverse ID to be applied, together with the original content (content before the edition). The content presentation control unit 323 then transmits the data of content individually edited for a specific metaverse in accordance with the acquisition of the ENG data from the user terminal 10 that joins the specific metaverse. As a result, it is possible to provide content individually edited in accordance with the analysis result for each metaverse.

Note that such individual edition of content is not limited to manual edition by a creator and may be automatically performed by the control unit 320 in accordance with a change scenario as shown in FIG. 8. Further, the control unit 320 is capable of arbitrarily reflecting information regarding the difference from the original content occurred when performing the individual edition on content for another metaverse. For example, such control that the control unit 320 transmits the edition result (which may be information regarding the difference from the original content) to a specific metaverse as well as reflects, in the case where a change in a certain index of the ENG data has been observed, the edition result on another metaverse is conceivable.

### <<3-3. Third Modified Example>>

The function of the content server 30 may be incorporated in the metaverse server 20 as an extension function.

In the metaverse server 20, the ENG data may be acquired from the user terminal 10, the validity of the ENG data may be confirmed (authentication may be performed), and control of presentation of content (control of permitting or blocking presentation of content) in the user terminal 10 may be performed. Further, in the metaverse server 20, the ENG data may be analyzed and the analysis result may be transmitted to the creator terminal 50.

As described above, the information processing system according to this embodiment may have a configuration in which the content server 30 is integrated with the metaverse server 20.

### 4. Hardware Configuration

Next, an example of a hardware configuration of an information processing apparatus 900 that is an example of the content server 30 according to an embodiment of the present disclosure will be described with reference to FIG. 10. FIG. 10 is a block diagram showing an example of the hardware configuration of the information processing apparatus 900. Note that the content server 30 does not necessarily need to have all the hardware configurations shown in FIG. 10 and the content server 30 does not necessarily need to include some of the hardware configurations shown in FIG. 10. Further, the example of the hardware configuration shown in FIG. 10 is applicable to the metaverse server 20, the user terminal 10, the creator terminal 50, the content management server 35, or the database server 37.

As shown in FIG. 10, the information processing apparatus 900 includes a central processing unit (CPU) 901, a read only memory (ROM) 902, and a random access memory (RAM) 903. Further, the information processing apparatus 900 may include a host bus 907, a bridge 909, an external bus 911, an interface 913, an input device 915, an output device 917, a storage device 919, a drive 921, a connection port 923, and a communication device 925. The information processing apparatus 900 may include a processing circuit called a digital signal processor (DSP) or an application specific integrated circuit (ASIC) instead of or in addition to the CPU 901.

The CPU 901 functions as an arithmetic processing unit and a control device and controls the general operations or part thereof in the information processing apparatus 900 in accordance with various programs recorded on the ROM 902, the RAM 903, the storage device 919, or a removable recording medium 927. The ROM 902 stores programs to be used by the CPU 901, operation parameters, and the like. The RAM 903 temporarily stores programs to be used when executed by the CPU 901, parameters that appropriately change in the execution. The CPU 901, the ROM 902, and the RAM 903 are connected to each other by the host bus 907 including an internal bus such as a CPU bus. Further, the host bus 907 is connected to the external bus 911 such as a peripheral component interconnect/interface (PCI) bus via the bridge 909.

The input device 915 is, for example, a device that is operated by a user, such as a button. The input device 915 may include a mouse, a keyboard, a touch panel, a switch, and a lever. Further, the input device 915 may include a microphone that detects voice of a user. The input device 915 may be, for example, a remote control device using infrared rays or another radio wave or an external connection device 929 corresponding to an operation of the information processing apparatus 900, such as a mobile phone. The input device 915 includes an input control circuit that generates an input signal on the basis of the information input by a user and outputs the generated input signal to the CPU 901. The user operates this input device 915 to input various types of data or instruct a processing operation to the information processing apparatus 900. Further, the input device 915 may include an imaging device. The imaging device images, for example, movement of the user's hand and the user's finger. At this time, the pointing position may be determined in accordance with the movement of the hand or the orientation of the finger.

The output device 917 includes a device capable of visually or audibly notifying of a user the acquired information. The output device 917 may be, for example, a display device such as a liquid crystal display (LCD) and an organic electro-luminescence (EL) display or an audio output device such as a speaker and a headphone. Further, the output device 917 may include a plasma display panel (PDP), a projector, a hologram, a printer device, or the like. The output device 917 outputs the result obtained by the processing of the information processing apparatus 900 as text, video such as an image, or sound such as audio and acoustic. Further, the output device 917 may include a light to brighten the surroundings.

The storage device 919 is a device for data storage, which is configured as an example of the storage unit of the information processing apparatus 900. The storage device 919 includes, for example, a magnetic storage device such as a hard disk drive (HDD), a semiconductor storage device, an optical storage device, or a magneto-optical storage device. This storage device 919 stores programs to be executed by the CPU 901, various types of data, various types of data acquired from the outside, and the like.

The drive 921 is a reader/writer for the removable recording medium 927 such as a magnetic disc, an optical disc, a magneto-optical disc, and a semiconductor memory and is built in or attached to the information processing apparatus 900. The drive 921 reads the information recorded on the attached removable recording medium 927 and outputs the read information to the RAM 903. Further, the drive 921 writes a record to the attached removable recording medium 927.

The connection port 923 is a port for directly connecting a device to the information processing apparatus 900. The connection port 923 may be, for example, a universal serial bus (USB) port, an IEEE1394 port, or a small computer system interface (SCSI) port. Further, the connection port 923 may be an RS-232C port, an optical audio terminal, or a high-definition multimedia interface (HDMI) (registered trademark) port. By connecting the external connection device 929 to the connection port 923, various types of data can be exchanged between the information processing apparatus 900 and the external connection device 929.

The communication device 925 is, for example, a communication interface including a communication device for connecting to a network 931. The communication device 925 may be, for example, a wired or wireless local area network (LAN), Bluetooth (registered trademark), or a communication card for a Wireless USB (WUSB). Further, the communication device 925 may be a router for optical communication, a router for asymmetric digital subscriber line (ADSL), or a modem for various types of communication. The communication device 925 transmits signals or the like using a predetermined protocol such as TCP/IP with the Internet or another communication device, for example. Further, the network 931 to be connected to the communication device 925 is a wired or wirelessly connected network and is, for example, the internet, a home LAN, infrared communication, radio wave communication, or satellite communication.

### 5. Supplement

Although a favorable embodiment of the present disclosure has been described above in detail with reference to the accompanying drawings, the present technology is not limited to such an example. It is obvious that a person having ordinary knowledge in the technical field of the present disclosure could conceive of various modified examples or modifications within the scope of the technical idea described in the claims and it is understood that these also naturally belong to the technical scope of the present disclosure.

For example, one or more computer programs for exhibiting the function of the content server 30, the metaverse server 20, the user terminal 10, the creator terminal 50, the content management server 35, or the database server 37 can be created in hardware such as a CPU, a ROM, and a RAM incorporated in the content server 30, the metaverse server 20, the user terminal 10, the creator terminal 50, the content management server 35, or the database server 37 described above. Further, a computer-readable storage medium storing the one or more computer programs is also provided.

Further, the effects described in the present specification are only descriptive or exemplary and are not restrictive. That is, the technology according to the present disclosure can exhibit other effects apparent to those skilled in the art from the description of the present specification in addition to or instead of the effects described above.

It should be noted that the present technology may also take the following configurations while remaining within the technical scope of the present disclosure.

(1) An information processing apparatus including:
circuitry configured to
acquire engagement data from a user terminal in relation to a presentation of a first content for a first period,
confirm validity of the acquired engagement data, store the acquired engagement data for which validity is confirmed to a
corresponding engagement data database, and
initiate presentation of a second content by the user terminal for a second period.

(2) The information processing apparatus according to (1), in which the presentation of at least one of the first or second content by the user terminal includes display of the content by a display device of the user terminal.

(3) The information processing apparatus according to (1) or (2), in which at least one of the first or second content includes at least one of a three-dimensional image, a two-dimensional image, a moving image, or audio data.

(4) The information processing apparatus according to any of (1) to (3), in which when the acquired engagement data is confirmed to be invalid, the circuitry is further configured to block the presentation of the second content by the user terminal.

(5) The information processing apparatus according to any of (1) to (4), in which the circuitry blocks the presentation of the second content by the user terminal by transmitting information preventing the second content from being decrypted.

(6) The information processing apparatus according to any of (1) to (5), in which the first content for the first period is same as the second content for the second period.

(7) The information processing apparatus according to any of (1) to (6), in which the first content for the first period is different from the second content for the second period.

(8) The information processing apparatus according to any of (1) to (7), in which the second content is determined based on the acquired engagement data.

(9) The information processing apparatus according to any of (1) to (8), in which the second content is determined based on an input to edit content received from a creator terminal.

(10) The information processing apparatus according to any of (1) to (9), in which the input to edit the first content is based on engagement data acquired in real time.

(11) The information processing apparatus according to any of (1) to (10), in which the second content is edited automatically.

(12) The information processing apparatus according to any of (1) to (11), in which the second content is determined based on an analysis result in accordance with a change scenario generated in advance and stored by a content server.

(13) The information processing apparatus according to any of (1) to (12), in which the first content is presented in a first metaverse and a second metaverse.

(14) The information processing apparatus according to any of (1) to (13), in which the circuitry acquires a first engagement data with respect to the presentation of the first content in the first metaverse and acquires a second engagement data with respect to the presentation of the first content in the second metaverse.

(15) The information processing apparatus according to any of (1) to (14), in which the circuitry acquires a plurality of types of the first engagement data with respect to the presentation of the first content in the first metaverse and a plurality of types of the second engagement data with respect to the presentation of the first content in the second metaverse.

(16) The information processing apparatus according to any of (1) to (15), in which behaviors included in the plurality of types of the first engagement data are determined for the first metaverse based on a first engagement data definition list generated for the first metaverse, and behaviors included in the plurality of types of the second engagement data are determined for the second metaverse based on a second engagement data definition list generated for the second metaverse.

(17) The information processing apparatus according to any of (1) to (16), in which the second content presented in the first metaverse is determined based on the acquired first engagement data and a third content presented in the second metaverse is determined based on the acquired second engagement data, and the first, second, and third contents are different from each other.

(18) The information processing apparatus according to any of (1) to (17), in which the circuitry initiates presentation of the second content by the user terminal for the second period only when the engagement data acquired from the user terminal in relation to the presentation of the first content for the first period is confirmed to be valid.

(19) An information processing method including:
acquiring engagement data from a user terminal in relation to a presentation of a first content for a first period;
confirming validity of the acquired engagement data;
storing the acquired engagement data for which validity is confirmed to a corresponding engagement data database; and
initiating presentation of a second content by the user terminal for a second period.

(20) A non-transitory computer-readable medium having embodied thereon a program, which when executed by a computer causes the computer to execute an information processing method, the method comprising:
acquiring engagement data from a user terminal in relation to a presentation of a first content for a first period;
confirming validity of the acquired engagement data;
storing the acquired engagement data for which validity is confirmed to a corresponding engagement data database; and
initiating presentation of a second content by the user terminal for a second period.

(B1) An information processing apparatus, including:
an acquisition unit that acquires data indicating behavior of a user who joins a virtual space on first content disposed in the virtual space in a first predetermined period;
a checking unit that checks validity of the data; and
a presentation control unit that controls, on the basis of a result of checking the validity, presentation of second content in a second predetermined period after the first predetermined period in a user terminal used by the user.

(B2) The information processing apparatus according to (B1) above, in which the presentation control unit performs, where it has been confirmed that the data is valid, control such that the second content is presented in the user terminal in the second predetermined period.

### (B3)

The information processing apparatus according to (B2) above, in which the presentation control unit performs control of transmitting, to the user terminal, information indicating that presentation of the second content is permitted.

(B4) The information processing apparatus according to any one of (B1) to (B3) above, in which
the presentation control unit performs, where it has been confirmed that the data is not valid, control of blocking presentation of the second content in the user terminal in the second predetermined period.

(B5) The information processing apparatus according to (B4) above, in which the presentation control unit blocks the presentation of the second content by avoiding transmitting information indicating that the presentation of the second content is permitted.

(B6) The information processing apparatus according to (B4) above, in which the presentation control unit blocks the presentation of the second content by transmitting information indicating that the presentation of the second content is not permitted.

(B7) The information processing apparatus according to any one of (B1) to (B6) above, in which
the second content is the first content.

(B8) The information processing apparatus according to any one of (B1) to (B6) above, in which
the second content is content obtained by changing the first content on the basis of the data indicating the behavior of the user.

(B9) The information processing apparatus according to (B8) above, in which the presentation control unit performs, in control of permitting the presentation of the second content based on the result of checking the validity of the data, control of transmitting, to the user terminal, the data of the second content obtained by changing the first content and the information indicating that the presentation of the second content is permitted.

(B10) The information processing apparatus according to (B1) above, in which the presentation control unit performs, where it has been confirmed that the data is valid, control of transmitting, to the user terminal, information indicating the second predetermined period in which the presentation of the second content is permitted as control of permitting the presentation of the second content.

(B11) The information processing apparatus according to any one of (B1) to (B10) above, in which
the data indicating the behavior of the user is determined by data defined in a behavior definition list in advance.

(B12) The information processing apparatus according to any one of (B1) to (B11) above, further including:
a storage unit that stores data indicating behavior of each user on the first content; and an analysis unit that analyzes the data indicating the behavior of each user stored in the storage unit.

(B13) The information processing apparatus according to (B12) above, in which the first content is provided to a plurality of virtual spaces, and
the analysis unit analyzes, for each of the plurality of virtual spaces, data indicating behavior of each user on the first content in the plurality of virtual spaces.

(B14) The information processing apparatus according to (B12) or (B13) above, in which
control of transmitting a result of the analysis performed by the analysis unit to a creator terminal used by a creator who has generated the first content is performed.

(B15) The information processing apparatus according to (B14) above, in which the second content is content obtained by editing the first content on the basis of the analysis result of the analysis unit by the creator using the creator terminal.

(B16) The information processing apparatus according to (B13) above, in which the second content is content obtained by automatically changing the first content on the basis of a result of analyzing the data indicating the behavior of the user by the analysis unit.

(B17) The information processing apparatus according to any one of (B1) to (B16) above, in which
the content is one of a 3D model, a moving image, a 2D image, and audio data.

(B18) An information processing method, including by a processor:
acquiring data indicating behavior of a user who joins a virtual space on first content disposed in the virtual space in a first predetermined period;
checking validity of the data; and
controlling, on a basis of a result of checking the validity, presentation of second content in a second predetermined period after the first predetermined period in a user terminal used by the user.

(B19) A program that causes a computer to function as:
an acquisition unit that acquires data indicating behavior of a user who joins a virtual space on first content disposed in the virtual space in a first predetermined period;
a checking unit that checks validity of the data; and
a presentation control unit that controls, on the basis of a result of checking the validity, presentation of second content in a second predetermined period after the first predetermined period in a user terminal used by the user.

(B20) An information processing terminal, including:
a transmission unit that transmits, to a server, data indicating behavior of a user who joins a virtual space on first content disposed in the virtual space in a first predetermined period; and
a control unit that controls presentation of second content in accordance with information regarding control of presentation of the second content in a second predetermined period after the first predetermined period based on a result of checking validity of the data by the server.

(B21) The information processing terminal according to (B20) above, wherein the control unit performs, where the server permits presentation of the second content, control of presenting the second content in the second predetermined period.

(B22) The information processing terminal according to (B20) or (B21) above, wherein
Information indicating the second predetermined period in which the presentation of the second content is permitted is received from the server.

(B23) The information processing terminal according to any one of (B20) to (B22) above, wherein
the control unit performs, where the server does not permit the presentation of the second content, control of blocking the presentation of the second content in the second predetermined period.

(B24) The information processing terminal according to any one of (B20) to (B23) above, wherein
the second content is the first content.

(B25) The information processing terminal according to any one of (B20) to (B23) above, wherein
the second content is content obtained by changing the first content on a basis of the data indicating the behavior of the user.

(B26) The information processing terminal according to (B25) above, wherein information indicating that the presentation of the second content is permitted and data of the second content obtained by changing the first content are received from the server.

(B27) The information processing terminal according to any one of (B20) to (B26) above, wherein
the data indicating the behavior of the user is determined by data defined in a behavior definition list in advance.

(B28) The information processing terminal according to any one of (B20) to (B27) above, wherein
the second content is obtained by changing the first content on the basis of a result of analyzing the data indicating the behavior of the user by the server.

(B29) The information processing terminal according to any one of (B20) to (B28) above, wherein
the content is one of a 3D model, a moving image, a 2D image, and audio data.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1, 2 information processing system
10 user terminal
20 metaverse server
30 content server
310 communication unit
320 control unit
321 content usage registration processing unit
322 ENG data checking unit
323 content presentation control unit
324 ENG analysis unit
330 storage unit
331 content data DB
332 ENG definition list DB
333 (333a, 333b, 333c, . . . ) ENG data DB
40 network
50 creator terminal
35 content management server
37 database server

1. An information processing apparatus comprising:
circuitry configured to
acquire engagement data from a user terminal in relation to a presentation of a first content for a first period,
confirm validity of the acquired engagement data, store the acquired engagement data for which validity is confirmed to a corresponding engagement data database, and
initiate presentation of a second content by the user terminal for a second period.

2. The information processing apparatus according to claim 1,
wherein the presentation of at least one of the first or second content by the user terminal includes display of the content by a display device of the user terminal.

3. The information processing apparatus according to claim 1,
wherein at least one of the first or second content includes at least one of a three-dimensional image, a two-dimensional image, a moving image, or audio data.

4. The information processing apparatus according to claim 1,
wherein when the acquired engagement data is confirmed to be invalid, the circuitry is further configured to block the presentation of the second content by the user terminal.

5. The information processing apparatus according to claim 4,
wherein the circuitry blocks the presentation of the second content by the user terminal by transmitting information preventing the second content from being decrypted.

6. The information processing apparatus according to claim 1,
wherein the first content for the first period is same as the second content for the second period.

7. The information processing apparatus according to claim 1,
wherein the first content for the first period is different from the second content for the second period.

8. The information processing apparatus according to claim 7,
wherein the second content is determined based on the acquired engagement data.

9. The information processing apparatus according to claim 8,
wherein the second content is determined based on an input to edit content received from a creator terminal.

10. The information processing apparatus according to claim 9,
wherein the input to edit the first content is based on engagement data acquired in real time.

11. The information processing apparatus according to claim 7,
wherein the second content is edited automatically.

12. The information processing apparatus according to claim 1,
wherein the second content is determined based on an analysis result in accordance with a change scenario generated in advance and stored by a content server.

13. The information processing apparatus according to claim 1,
wherein the first content is presented in a first metaverse and a second metaverse.

14. The information processing apparatus according to claim 13,
wherein the circuitry acquires a first engagement data with respect to the presentation of the first content in the first metaverse and acquires a second engagement data with respect to the presentation of the first content in the second metaverse.

15. The information processing apparatus according to claim 14,
wherein the circuitry acquires a plurality of types of the first engagement data with respect to the presentation of the first content in the first metaverse and a plurality of types of the second engagement data with respect to the presentation of the first content in the second metaverse.

16. The information processing apparatus according to claim 14,
wherein behaviors included in the plurality of types of the first engagement data are determined for the first metaverse based on a first engagement data definition list generated for the first metaverse, and
wherein behaviors included in the plurality of types of the second engagement data are determined for the second metaverse based on a second engagement data definition list generated for the second metaverse.

17. The information processing apparatus according to claim 14,
wherein the second content presented in the first metaverse is determined based on the acquired first engagement data and a third content presented in the second metaverse is determined based on the acquired second engagement data, and
wherein the first, second, and third contents are different from each other.

18. The information processing apparatus according to claim 1,
wherein the circuitry initiates presentation of the second content by the user terminal for the second period only when the engagement data acquired from the user terminal in relation to the presentation of the first content for the first period is confirmed to be valid.

19. An information processing method comprising:
acquiring engagement data from a user terminal in relation to a presentation of a first content for a first period;
confirming validity of the acquired engagement data;
storing the acquired engagement data for which validity is confirmed to a corresponding engagement data database; and
initiating presentation of a second content by the user terminal for a second period.

20. A non-transitory computer-readable medium having embodied thereon a program, which when executed by a computer causes the computer to function as execute an information processing method, the method comprising:
acquiring engagement data from a user terminal in relation to a presentation of a first content for a first period;
confirming validity of the acquired engagement data;
storing the acquired engagement data for which validity is confirmed to a corresponding engagement data database; and
initiating presentation of a second content by the user terminal for a second period.
